(19) United States
(12) Patent Application Publication
(10) Pub. No.: US 2016/0078773 A1
(43) Pub. Date: Mar. 17, 2016

(54) SYSTEM AND METHOD OF PROVIDING TASK-BASED SOLICITATION OF REQUEST RELATED USER INPUTS

(71) Applicant: VOICEBOX TECHNOLOGIES CORPORATION, Bellevue, WA (US)

(72) Inventors: Daniel B. CARTER, REDMOND, WA (US); Michael R. KENNEWICK, BELLEVUE, WA (US)

(73) Assignee: VOICEBOX TECHNOLOGIES CORPORATION, BELLEVUE, WA (US)

(21) Appl. No.: 14/855,598

(22) Filed: Sep. 16, 2015

Related U.S. Application Data
(60) Provisional application No. 62/051,704, filed on Sep. 17, 2014.

(51) Int. Cl. G09B 7/02

(52) U.S. Cl. CPC G09B 7/02

(57) ABSTRACT

In certain implementations, a training environment is provided. A task that is to be performed is provided. The task may relate to a user request that is invokeable in one or more other environments different than the training environment. One or more user inputs may be received for the training environment. A determination of whether performance of the task has been satisfied may be effectuated based on the one or more user inputs. A reward may be provided for a user in response to a determination that performance of the task has been satisfied. In some implementations, the determination of whether performance of the task has been satisfied may comprise a determination of whether the user request would have been invoked in the one or more other environments if the user inputs had been received for the one or more other environments.

### CROSS REFERENCE TO RELATED APPLICATION

This application claims the benefit of U.S. Provisional Patent Application Ser. No. 62/051,704 filed Sep. 17, 2014 entitled “SYSTEM AND METHOD OF PROVIDING TASK-BASED SOLICITATION OF REQUEST RELATED USER INPUTS”, the entirety of which is incorporated herein by reference.

### FIELD OF THE INVENTION

The invention relates to systems and methods of providing task-based solicitation of request-related user inputs.

### BACKGROUND OF THE INVENTION

With the advent of technology, consumer electronic devices have emerged to become nearly ubiquitous in the everyday lives of many people. Many of these devices offer users access to a plethora of features. However, a greater number of features also introduces trade-offs, including, for example, greater learning curves that often inhibit users from fully exploiting many of the features available to them. As market research suggests, many users only use a fraction of the features available on a given device. Reasons for the failure or refusal of users to use features that are available to them may include lack of awareness of the features, a negative experience with related experience, or other reasons.

The failure or refusal of users to use features that are available to them is particularly a significant issue where there are no visible user interface items that correspond to each feature. For example, while many user devices enable users to initiate requests (e.g., commands, queries, etc.) using speech, users may still utilize other techniques that are less inefficient to initiate their requests (e.g., maneuvering through user interface items via clicking or tapping of the user interface items). While some applications provide users with help/tips screens (or other forms of assistance) that presents the users with a list of available voice requests and the corresponding key phrases required to initiate the voice requests, the foregoing help/tips screens are often limited to a small subset of the available voice requests and corresponding key phrases to avoid overwhelming users. These and other drawbacks exist.

### SUMMARY OF THE INVENTION

The invention relates to systems and methods of providing task-based solicitation of request-related user inputs, providing a training environment to solicit users to perform a task by providing user inputs for invoking a user request related to the task, rewarding users for performance of tasks related to user requests, enabling features related to user requests for performance of tasks related to user requests, presenting analysis regarding tasks and/or task-related user requests, or updating grammar and/or profile information based on information regarding user inputs provided in response to tasks.

In an implementation, the system may provide one or more tasks to users where performance of the tasks are satisfied when the users provide user inputs for invoking user requests related to the task. As an example, the tasks may be provided to users to train users to initiate user requests using natural language inputs (e.g., natural language utterances, gestures, etc.) in situations where there may be little (or no) guidance from visible user interface items corresponding to the user requests that can be invoked. As another example, the tasks may be provided to users to train the system. Because each task may be related to a limited set of user requests (or categories of user requests), the system can assume with sufficient confidence that a user input provided in response to a task is likely intended for invoking at least one user request of the set of user requests (or categories of user requests). As such, when users provide user inputs for a task, the user inputs can be analyzed by the system (e.g., using a machine-learning algorithm) to determine how the users would naturally invoke one or more user requests related to the task (using speech, gestures, etc.). Information from such analysis may, for example, then be utilized to update grammar information associated with the user requests (or the categories of user requests), profile information associated with the user, etc.

In an implementation, the system may provide a training environment in which users may perform tasks related to user requests. In some implementations, user inputs provided in the training environment for a task that would typically invoke a user request to be executed by a particular application (if the user inputs were provided outside of the training environment) may not invoke the application to execute the user request. In this way, a user may practice providing user inputs for invoking user requests with guidance from tasks without worrying about actually invoking user requests and incurring the associated tangible effects. It should be noted that, in other implementations, user inputs provided in the training environment for a task may invoke a user request to be executed by one or more applications having access to live, real-time data, communication with one or more other users, etc. (e.g., as if the user inputs had been provided outside the training environment).

Various other aspects of the invention will be apparent through the detailed description of the invention and the drawings attached hereto. It is also to be understood that both the foregoing general description and the following detailed description are exemplary and not restrictive of the scope of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 illustrates a system for providing task-based solicitation of request-related user inputs, according to an implementation of the invention.

FIG. 2 illustrates a system for facilitating natural language processing, according to an implementation of the invention.

FIG. 3 illustrates a flow diagram for a method of providing task-based solicitation of request-related user inputs, according to an implementation of the invention.

FIG. 4 illustrates a flow diagram for a method of providing task-based solicitation of request-related natural language inputs that comprise representations of words, according to an implementation of the invention.

FIG. 5 illustrates a flow diagram for a method of assessing performance of a task based on a threshold level of accuracy associated with a training environment, according to an implementation of the invention.

FIG. 6 illustrates a flow diagram for a method of allocating rewards based on efficiency of user inputs for invoking user requests, according to an implementation of the invention.

FIG. 7 illustrates a flow diagram for a method of updating grammar and/or profile information based on information regarding user inputs provided for tasks, according to an implementation of the invention.

FIGS. 8A-8C illustrates screenshots of a user interface which facilitates task-based solicitation of request-related user inputs, according to an implementation of the invention.

FIGS. 9A-9C illustrates screenshots of a user interface which facilitates task-based solicitation of user inputs matching a phrase associated with a user request, according to an implementation of the invention.

FIG. 10 illustrates a screenshot of a user interface that provides a comparison between categories of user requests submitted by a user, according to an implementation of the invention.

FIG. 11 illustrates a screenshot of a user interface that provides a comparison between efficiency levels for each category of user requests submitted by a user, according to an implementation of the invention.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

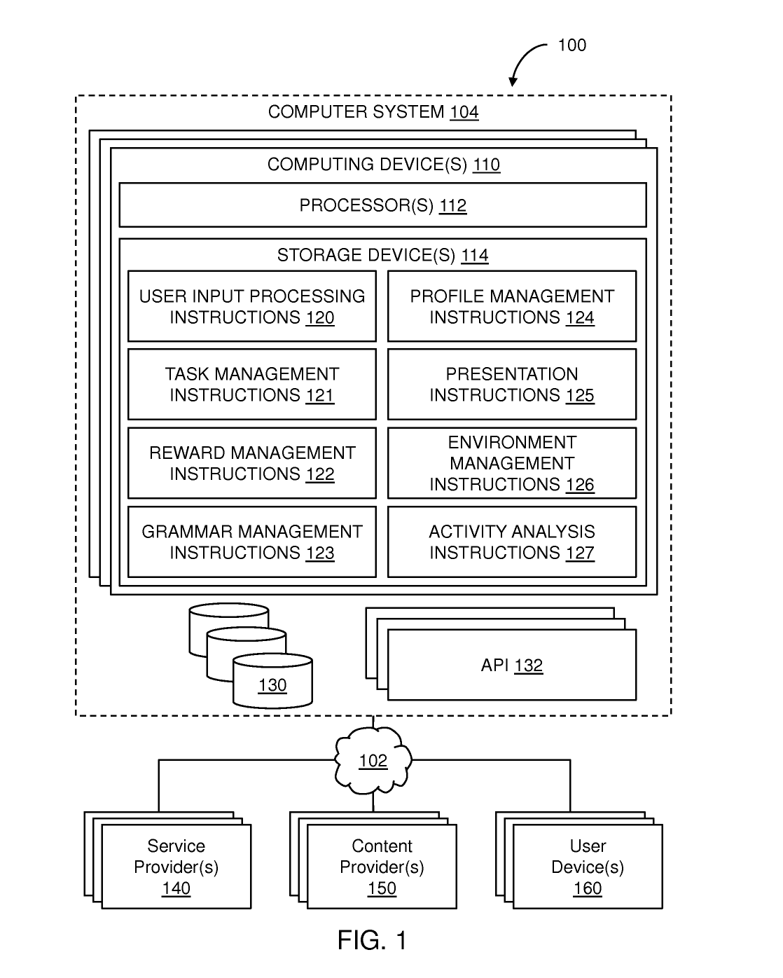

FIG. 1 illustrates a system 100 of providing task-based solicitation of request-related user inputs, according to an implementation of the invention. In an implementation, system 100 may provide one or more tasks related to one or more user requests. The user requests may comprise a command, a query, or other user request that is recognizable by system 100. The tasks may comprise a task that solicits a user input from a user for invoking a related user request. System 100 may receive one or more user inputs, and determine whether performance of a task has been satisfied based on the user inputs. The user inputs may comprise an auditory input (e.g., received via a microphone), a visual input (e.g., received via a camera), a tactile input (e.g., received via a touch sensor device), an olfactory input, a gustatory input, a keyboard input, a mouse input, or other user input. As an example, a natural language utterance, a gesture (or other body movements), or other user input may be received from a user and processed to determine whether performance of a task presented to the user has been satisfied.

In an implementation, system 100 may determine whether performance of a task has been satisfied by determining whether a received user input corresponds to a valid user request related to the task. As an example, system 100 may determine whether a natural language processing system would invoke the task-related user request upon receipt of the user input.

In one use case, if the user input is a natural language utterance spoken by a user, the natural language utterance may be processed by a speech recognition engine to recognize one or more words of the natural language utterance. The recognized words may then be processed, along with context information associated with the user, by a natural language processing engine to determine a user request intended by the user when the user provided the natural language utterance. System 100 may determine that performance of the task has been satisfied if, for example, the task can be completed upon execution of the determined user request. A determination of the user request may, for instance, comprise predicting one or more potential user requests intended by the user, assigning a confidence score to each of the potential user requests, and selecting the potential user request with the highest confidence score as the user request intended by the user.

In an implementation, system 100 may provide a task that specifies a set of words related to a user request. System 100 may receive a user input comprising a representation of one or more words (e.g., audio stream of an utterance of a user, video stream of sign language-based hand signals, or other representation of the words). Regardless of whether the set of words specified by the task comprise the words represented by the received user input, system 100 may determine that the performance of the task has been satisfied if, for example, a natural language processing system would invoke the task-related user request upon receipt of the user input. As an example, if a task presented to a user solicits the user to perform an action and specifies examples of phrases that the user can provide to perform the solicited action, the user's input need not be limited to the example phrases specified by the task to perform the solicited action. In one use case, the solicited action may comprise adding a reminder to the user's calendar, and an example phrase specified by the task may comprise “Add a reminder to my calendar.” Nevertheless, the user may say “Remind me to buy milk tomorrow afternoon,” and the task may be deemed to be satisfied if a valid user request can be determined from the user's natural language utterance.

In an implementation, system 100 may provide a reward to a user in response to a determination that performance of a task has been satisfied. The reward may comprise points, badges (e.g., a graphical indicator of accomplishment, skill, quality, interest, etc.), real-world money, virtual currency, promotional offers (e.g., coupons, rebates, etc.), products, services, or other reward. The reward may be based on the extent to which the task was performed (e.g., a threshold amount of completed sub-tasks), the quality of the performance of the task (e.g., the extent to which a user input matches a phrase specified by the task, a confidence score assigned to a prediction that a task-related user request was intended by a user in providing a user input, etc.), the level of efficiency with which the task was performed, or other criteria.

In an implementation, system 100 may enable access of a user to one or more features in response to a determination that performance of a task has been satisfied. As an example, a task related to a user request may be presented to a user. At the time the task is presented to the user, access of the user to a set of features related to the user request may be disabled. Upon a determination that the user has performed the task, access of the user to the set of features related to the user request may be enabled.

In an implementation, system 100 may store information regarding one or more user inputs related to a task provided by system 100. The information regarding the user inputs may be determined based on a processing of the user inputs. Such information may indicate words represented by a user input, the order in which the words are represented by the user input, intensities of the user input (e.g., speed, volume, power per unit area, etc.), pitches of the user input (e.g., a user's pitches in speaking various words of an utterance), variations of the user input with respect to a predefined norm (e.g., a user's pronunciations of words compared to a predefined pronunciation of those words), or other information. The stored information regarding the user inputs may, for example, be utilized with other information (e.g., regarding other user inputs) to update grammar information, profile information, etc.

In an implementation, system 100 may determine one or more user requests that are related to a task presented to a user. System 100 may update grammar information associated with the user requests based on information regarding a user input that the user provided to perform the task. System 100 may receive one or more other user inputs of another user. System 100 may process the other user inputs based the updated grammar information to determine a user request of the other user. As an example, the information regarding the user input of the user may indicate the words represented by the user input and the order in which the words are represented by the user input. The words and their corresponding order may be utilized to update the grammar information associated with the user requests.

In an implementation, system 100 may update profile information associated with a user based on information regarding a user input that the user provided to perform a task related to a user request. System 100 may receive one or more other user inputs of the user. System 100 may process the other user inputs based on the updated profile information to determine one or more other user requests of the user. As an example, the information regarding a user input of the user may indicate variations of the user input with respect to a predefined norm (e.g., the user's pronunciations of words compared to a predefined pronunciation of those words). The indications variations of the user input may be utilized to update the profile information associated with the user, for example, so that the variations may be considered when processing subsequent user inputs (e.g., utterances) of the user, reinterpreting previous user inputs of the user, etc.

Other uses of system 100 are described herein and still others will be apparent to those having skill in the art. Having described a high level overview of some of the system functions, attention will now be turned to various system components that facilitate these and other functions.

System Components

System 100 may include a computer system 104, one or more service providers 140, one or more content providers 150, one or more user devices 160, and/or other components. Computer system 104 may interface with service provider(s) 140 to allow users access to services offered by service provider(s) 140, interface with content provider(s) 150 to allow users to access content offered by content provider(s) 150, and provide various interfaces to user device(s) 160 so that users may interact with computer system 104.

To facilitate these and other functions, computer system 104 may include one or more computing devices 110. Each computing device 110 may include one or more processors 112, one or more storage devices 114, one or more databases 130, one or more APIs 132 (e.g., to interface with service provider(s) 140, content provider(s) 150, user device(s) 160, etc.), and/or other components.

Processor(s) 112 may be programmed with one or more computer program instructions, which may be stored in storage device(s) 114, to perform one or more operations. The one or more computer program instructions may comprise user input processing instructions 120, task management instructions 121, reward management instructions 122, grammar management instructions 123, profile management instructions 124, presentation instructions 125, environment management instructions 126, activity analysis instructions 127, or other instructions.

In some implementations, a given user device 160 may comprise a given computer device 110. As such, the given user device 160 may comprise processor(s) 112 that are programmed with one or more computer program instructions, such as user input processing instructions 120, task management instructions 121, reward management instructions 122, grammar management instructions 123, profile management instructions 124, presentation instructions 125, environment management instructions 126, activity analysis instructions 127, or other instructions.

As used hereinafter, for convenience, the foregoing instructions will be described as performing an operation, when, in fact, the various instructions may program processor(s) 112 (and thereafter computer system 104) to perform the operation.

Task-Based Solicitation of Request-Related User Inputs in a Training Environment

In an implementation, environment management instructions 126 may manage and/or interface with one or more different types of environments. The different types of environments may handle different types of user requests, display different types of content, or provide other different offerings from one another. In one scenario, a first environment may comprise an environment for a first application (e.g., an application for training users to effectively use one or more other applications), and a second environment may comprise an environment for a second application (e.g., a game application, a navigation application, a music application, a weather application, or other application).

In an implementation, task management instructions 121 may manage a set of tasks that are available for users to perform, determine whether, when, and/or the extent to which the tasks are performed, identify the users that performed the tasks, etc. The set of tasks may comprise tasks related to valid user requests (e.g., commands, queries, or other user requests recognized by system 100). Such request-related tasks may comprise user requests that are invokeable in one or more other environments (different than a training environment in which the request-related tasks are provided to a user). Information associated with the set of tasks may be stored in one or more databases 130 (e.g., a task database). The task information associated with the set of tasks may indicate task identifiers associated with tasks, actions specified by each of the tasks for users to perform, user requests related to each of the specified actions, users that have perform particular tasks, rewards to be allocated to a user upon performance of a task, or other information.

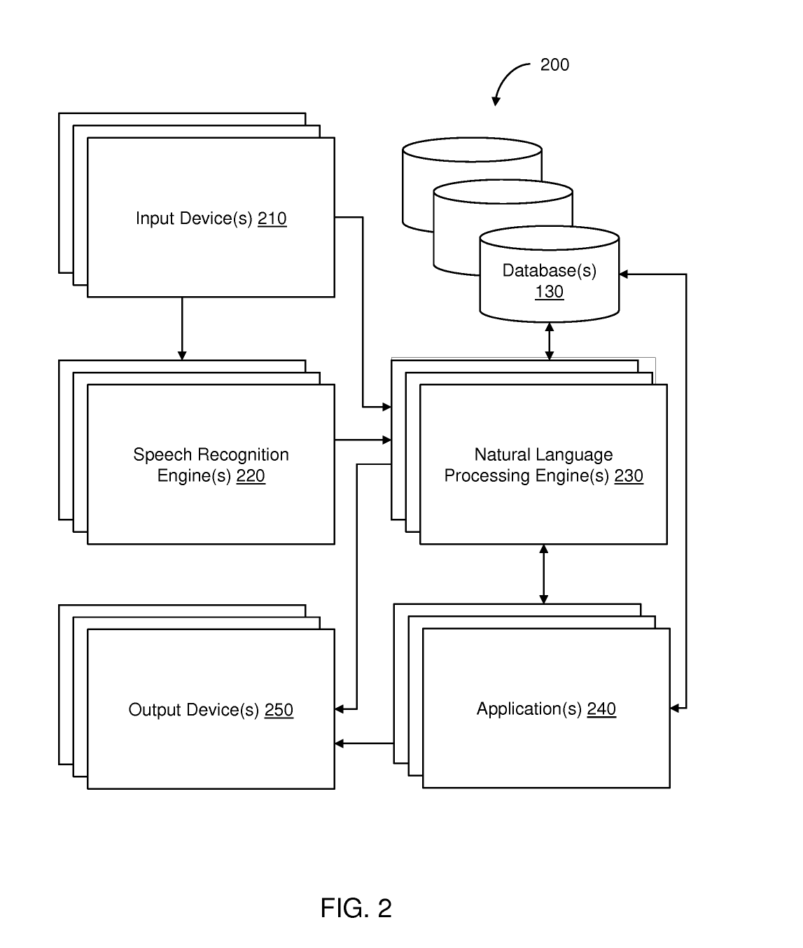

In an implementation, user input processing instructions 120 may process one or more user inputs of a user to determine one or more user requests that are intended by the user when the user provided the user inputs. The user inputs may comprise an auditory input (e.g., received via a microphone), a visual input (e.g., received via a camera), a tactile input (e.g., received via a touch sensor device), an olfactory input, a gustatory input, a keyboard input, a mouse input, or other user input. As described herein elsewhere, user input processing instructions 120 may comprise instructions associated with one or more speech recognition engines (e.g., speech recognition engine(s) 220 of FIG. 2), one or more natural language processing engines (e.g., natural language processing engine(s) 230 of FIG. 2), or other components for processing user inputs to determine user requests related to the user inputs.

In an implementation, environment management instructions 126 may provide a training environment in which a user can perform one or more tasks. The training environment may, for example, enable a training session for the user during which the user can perform one or more tasks, such as tasks assigned to the user to perform, tasks available for the user or other users to perform, etc. The tasks that the user can perform may comprise tasks related to one or more user requests (e.g., commands, queries, etc.) that are invokeable in one or more other environments different than the training environment. In one use case, the training environment may comprise a game environment in which tasks related to user requests are provided for users to perform, and the other environments may comprise one or more non-game environments outside of the game environment. In another use case, the training environment may comprise a training session within a game environment for a user to practice user requests that are invokeable in a game outside of the training session, and the other environments may comprise regular gameplay outside of the training session.

Task management instructions 121 may provide a task that is to be performed. For example, task management instructions 121 may provide the task for the user (that is accessing the training environment) to perform. User input processing instructions 120 may receive one or more user inputs for the training environment (e.g., a user input of the user), and/or process the user inputs to determine one or more user requests related to the user inputs.

Task management instructions 121 may determine whether performance of the task has been satisfied based on the received user inputs. As an example, the determination of whether performance of the task has been satisfied may be based on whether the user requests determined (by user input processing instructions 120) from the received user inputs comprise a user request related to the task.

In an implementation, after one or more user inputs are received in a training environment and processed by user input processing instructions 120, task management instructions 121 may determine whether performance of a task has been satisfied based on a determination of whether the user inputs would invoke a user request related to the task. As an example, the user request related to the task may comprise a command, a query, or other user request invokeable in one or more other environments (different than the training environment). If it is determined that the user request would have been invoked in the other environments (had the user inputs had been received for the other environments), then task management instructions 121 may determine that performance of at least a portion of the task (with respect to the particular user request) has been satisfied.

In an implementation, task management instructions 121 may provide a task that specifies a set of words related to a user request. The set of words may, for instance, comprise a predefined phrase that can be provided as an input to invoke the user request. In one implementation, performance of the assigned task may not be satisfied until a user provides a user input that comprises a representation of the predefined phrase. As an example, the user may be required to say the phrase such that the spoken phrase sufficiently matches the predefined phrase of the task.

In another implementation, the user's input need not be limited to representations of the predefined phrase. As an example, the user may provide a user input comprising a representation of words that are not included in the predefined phrase. Nevertheless, performance of the task (which specifies the predefined phrase) may be deemed to be satisfied based on a determination by user input processing instructions 120 that the user input would invoke the user request related to the task. In one scenario, if a task presented to a user solicits the user to perform an action and specifies examples of phrases that the user can provide to perform the solicited action, the user's input need not be limited to the example phrases specified by the task to perform the solicited action. By way of example, the solicited action may comprise adding a reminder to the user's calendar, and the example phrase specified by the task may comprise “Add a reminder to my calendar.” Nevertheless, the user may say “Remind me to buy milk tomorrow afternoon,” and the task may be deemed to be satisfied if a valid user request can be determined from the user's natural language utterance.

In an implementation, a threshold level of accuracy associated with a training environment for performing an action specified by a task (and related to a user request) may be different than a threshold level of accuracy associated with one or more other environments outside of the training environment. By way of example, user input processing instructions 120 may receive a user input from a user in response to the task being provided to the user. The user input may comprise a representation of the specified user action of the task. User input processing instructions 120 may determine a level of accuracy of the representation of the specified user action with respect to the specified user action. The level of accuracy may be determined based on similarities the portions of the representation from the user input and the portions of a predefined representation of the specified action (e.g., similarities between sounds of the corresponding portions), similarities between the order of the portions of the representation from the user input and the order of the portions of the predefined representation of the specified action (e.g., similarities with respect to how represented words are ordered), or other criteria.

Task management instructions 121 may determine whether performance of the task is satisfied based on a determination of whether the level of accuracy satisfies the threshold level of accuracy associated with the training environment. As an example, the specified action of the task may comprise repeating a phrase associated with a user request related to the task, and the representation of the phrase may comprise a natural language utterance provided by the user. In one use case, the threshold level of accuracy associated with the training environment may be greater than the threshold level of accuracy associated with the other environments. As such, even when the level of accuracy of the natural language utterance would otherwise be deemed to be accurate enough to the phrase to invoke the associated user request outside of the training environment, task management instructions 121 may determine that performance of the task is not satisfied if the level of accuracy of the natural language utterance does not satisfy the greater threshold level of accuracy associated with the training environment. Thus, the training environment may train users to provide user inputs with higher levels of accuracy than what is required outside of the training environment.

In another use case, the threshold level of accuracy associated with the training environment is less than the threshold level of accuracy associated with the other environments. Thus, even when the level of accuracy of the natural language utterance is not accurate enough to the phrase to invoke the associated user request outside of the training environment, task management instructions 121 may nevertheless determine that performance of the task is satisfied if the level of accuracy of the natural language utterance satisfies the lesser threshold level of accuracy associated with the training environment.

In an implementation, when a user provides one or more user inputs for performing a task in a training environment, a user request may not actually be invoked even though the user inputs would have invoked the user request if the user inputs had been provided in one or more other environments (different than the training environment). As an example, in response to the user inputs, presentation instructions 125 may present the user with a confirmation that performance of the task has been satisfied without actually invoking the user request (and, thus, the user request is not executed in either the training environment or one of the other environments). In this way, the training environment may provide users with an environment to practice “invoking” user requests without actually invoking and executing the user requests.

In an implementation, when a user provides one or more user inputs for performing a task in a training environment, a user request related to the user inputs may be invoked in one or more other environments (different than the training environment). In another implementation, a user request may be invoked in a training environment when a user provides one or more user inputs for performing a task related to the user request without invoking the user request in one or more other environments (different than the training environment). In one use case, for instance, the training environment may comprise a game environment associated with a game. In response to a user input related to a search query, the search query may be executed on a database designated for the game environment (e.g., a database with a sample subset of content for the user to practice searching with).

Rewards for Performance of Tasks

Reward management instructions 122 may provide a reward for a user in response to a determination that performance of a task has been satisfied. The reward may comprise points, badges (e.g., a graphical indicator of accomplishment, skill, quality, interest, etc.), real-world money, virtual currency, promotional offers (e.g., coupons, rebates, etc.), products, services, or other reward. The reward may be based on the extent to which the task was performed (e.g., a threshold amount of completed sub-tasks), the quality of the performance of the task (e.g., the extent to which a user input matches a phrase specified by the task, a confidence score assigned to a prediction that a task-related user request was intended by a user in providing a user input, etc.), the level of efficiency with which the task was performed, or other criteria.

In an implementation, after one or more user inputs are received from a user in a training environment and processed by user input processing instructions 120, task management instructions 121 may determine whether performance of a task has been satisfied based on a determination of whether the user inputs would invoke a user request related to the task. As an example, the user request related to the task may comprise a command, a query, or other user request invokeable in one or more other environments (different than the training environment). If it is determined that the user request would have been invoked in the other environments (had the user inputs had been received for the other environments), then task management instructions 121 may determine that performance of at least a portion of the task (with respect to the particular user request) has been satisfied. In response to the task being performed, reward management instructions 122 may allocate a reward associated with the task to the user.

In an implementation, reward management instructions 122 may provide rewards based on the efficiency with which tasks are performed, an amount of task-related guidance that is provided to the user, or other criteria. As an example, a value of a reward allocated to a user may be higher when the user performs tasks with greater efficiency (as compared to a value of a reward allocated to the user when the user performs tasks with less efficiency). As another example, a value of a reward allocated to a user may be higher when the user performs tasks with less task-related guidance (as compared to a value of a reward allocated to the user when the user performs tasks with greater task-related guidance). In other examples, a value of a reward allocated to a user may be higher when the user performs tasks with less efficiency and/or greater task-related guidance (as compared to a value of a reward allocated to the user when the user performs task with greater efficiency and/or less task-related guidance).

In an implementation, task management instructions 121 may interact with a user via one or more user devices 160 to solicit user inputs from the user that are related to a task to be performed. The task may, for instance, solicit user inputs for invoking one or more user requests. Task management instructions 121 may provide one or more responses to user inputs of the user and/or guidance related to the task to assist the user in performing the task. Presentation instructions 125 may present the responses and/or the guidance to the user.

When performance of the task has been satisfied, or while performance of the task is underway, task management instructions 121 may determine a level of efficiency of the user inputs of the user for invoking a user request related to the task. As an example, the level of efficiency of the user inputs may be determined based on the number of user inputs (or iterations of user inputs) that the user provided before a set of user inputs are deemed sufficient for invoking the user request, the number of responses (or iteration of responses) provided by task management instructions 121 to solicit the user inputs, an amount of guidance provided by task management instructions before receipt of a set of user inputs deemed sufficient for invoking the user request, or other criteria. Reward management instructions 122 may determine a reward to be allocated to the user based on the level of efficiency of the user inputs for invoking the user request.

In one scenario, a task assigned to a user during a training game may comprise setting a reminder, and presentation of the task to the user may comprise instructing the user to provide one or more user inputs to “Set a reminder.” If the user provides the utterance “Set a reminder,” user input processing instructions 120 may process the utterance to determine whether more information is needed from the user for invoking a user request to properly set a reminder (e.g., to a set an actual reminder outside of the training game). If it is determined that one or more parameters are unknown (or cannot be determined from the user's first utterance), user input processing instructions 120 and/or task management instructions 121 may prompt the user for more information in the form of questions, such as “What would you like me to remind you of?,” “When would you like to be reminded?,” etc. User input processing instructions 120 and/or task management processing instructions 121 may continue to process further user inputs and prompt the user for more information until the user's combined inputs are sufficient for invoking the user request for setting a reminder. The efficiency of the interaction to set a reminder may be determined based on the number of times that the user provided user inputs related to setting the reminder, the number of prompts (or other responses) provided to the user to solicit further information to set the reminder, or criteria. The determined efficiency may be utilized to determine a reward to be allocated to the user.

In an implementation, task management instructions 121 may determine an amount of task-related guidance that is provided to a user. Reward management instructions 122 may determine a reward to be allocated to the user for performing a task based on the amount of guidance (e.g., more reward when a greater amount of guidance is provided, less reward when a greater amount of guidance is provided, more reward when a lesser amount of guidance is provided, less reward when a lesser amount of guidance is provided, etc.). As an example, guidance may be provided as responses to a user input when the user input (and/or previous user inputs) is insufficient for invoking a user request related to the task (e.g., prompting the user for specific types of information related to unknown parameters).

As another example, guidance may be provided to the user during presentation of the task before any user inputs are provided by the user to perform the task. The amount of guidance provided during presentation of the task may, for instance, be based on a level of the user (e.g., a level in a training game, a level related to an amount of experience of the user in using a natural language processing system, etc.), a preference set by the user regarding the amount of guidance, or other criteria. In one use case, for example, a greater amount of guidance may be provided to “expert users” than the amount of guidance provided to other users with less experience. In another use case, a user may select to increase or reduce the amount of guidance provided to the user so that the user subsequently receives more or less guidance, respectively.

Access to Features for Performance of Tasks

In an implementation, profile management instructions 124 may enable access of a user to one or more features in response to performance of one or more tasks. As an example, access of a user to a feature of an environment may be disabled prior to a task assigned to the user being performed. However, after the user has performed the task, the access of the user to the feature may be enabled. Thus, access to one or more features may be enabled as a reward for performing one or more tasks.

In one use case, when a user has performed a task related to a first set of user requests, access of the user to invoke user requests of a second set of user requests may be enabled. As an example, in a game, a user that successful invokes a first set of commands (e.g., magic spells, attack moves, defense moves, etc.) assigned to the user to perform may be provided with access to invoke a second set of commands (e.g., more powerful spells, greater attack movies, greater defense moves, etc.). As another example, a user may not be able to invoke queries for products/services nearby via a navigation application until the user completes one or more tasks related to a set of basic user requests of the navigation application.

In another use case, when a user has performed (in a training environment) a task related to a user request that is invokeable in one or more other environments (different than the training environment), access of the user to invoke the user request related to the task in the other environments may be enabled. As an example, a user may not be able to invoke a certain set of navigation requests via a navigation application until the user completes one or more tasks related to the set of navigation requests in a training environment.

In an implementation, upon performance of one or more tasks in a training environment, profile management instructions 124 may modify a level associated with the user from a first level of the training environment to a second level of the training environment. Access to one or more features (e.g., access to invoke certain user requests) associated with one or more other environments (different than the training environment) may be enabled in response to the modification of the level associated with the user.

As an example, an application (e.g., a game application, a navigation application, a music application, a weather application, or other application) may check the level of the user to determine whether the application should execute a particular user request from a user. A higher level may, for instance, provide the user with access to invoke a greater number of user requests via the application, while a lower level may provide with the user with access to a lesser number of users requests via the application.

As another example, once a user reaches a particular level (e.g., an “expert” level), the user may be granted access to modify the verbosity settings of the user's voice interface (and/or of the underlining application). The granted access may, for instance, allow the user to modify the verbosity settings so that the user (or voice) interface will provide terser, less verbose responses (e.g., when using the interface within or outside the training environment). In this way, an expert user may have the option to be provided with terser, less verbose responses (or other outputs) that may improve their user experience (e.g., as a result of less need for guidance from more verbose responses). In other implementations, verbosity settings associated with a user (or the user's voice interface) may be automatically set based on a level of the user. For example, without the user specifying such settings, an expert user may be provided with terser, less verbose responses (or other outputs), while other users with less experience may be provided with more verbose responses (or other outputs) until they reach an experience level where it would be more efficient to provide them with the terser, less verbose responses (that are provided to expert users).

Updates Based on Task-Related User Input Information

In an implementation, grammar information, profile information, or other information may be updated based on information regarding user inputs of users that are received in response to tasks. As an example, user input processing instructions 120 may determine the information regarding the user inputs when processing the user inputs (e.g., to determine one or more user requests associated with the user inputs). Such information may indicate words represented by the user input, the order in which the words are represented by the user input, intensities of a user input (e.g., speed, volume, power per unit area, etc.), pitches of the user input (e.g., a user's pitches in speaking various words of an utterance), variations of a user input with respect to a predefined norm (e.g., a user's pronunciations of words compared to a predefined pronunciation of those words), or other information. Task management instructions 121, grammar management instructions 123, profile management instructions 124, or other components may store the information regarding the inputs, for instance, to subsequently update grammar information, profile information, or other information.

In an implementation, grammar management instructions 123 may determine one or more user requests related to a task performed by a user, and obtain information regarding user inputs of the user that were received in response to the task. Because the prior user inputs were received in response to the task with which the user requests are related, the prior user inputs are also likely to be related to the user requests. As such, grammar management instructions 123 may update grammar information associated with the determined user requests based on the information regarding the user inputs. Thereafter, other user inputs of the user and/or other user inputs of other users may be processed based on the updated grammar information to determine other user requests associated with the other user inputs.

In one use case, a task may be provided to a set of users in a training environment. The task may solicit the users to provide user inputs for setting a reminder. Upon receiving user inputs for the task, it may be determined that many of the user inputs comprise the phrase “Remind me to call [contact name] [date/time].” As an example, prior to updating grammar information associated with reminders based on information regarding the user inputs, a natural language processing system may generally give a greater weight to the action “Call” (compared to the action “Remind), resulting in some scenarios where variations of the phrase “Remind me to call [contact name]” is interpreted as a user request to call a contact. Nevertheless, because many of the users provided user inputs comprising the phrase “Remind me to call [contact name] [date/time]” in response to a task related to setting reminders, grammar management instructions 123 may determine that a greater weight should be assigned to the action “Remind” (compared to the action “Call”) during processing of a user input where, for example, the user input comprise the word “Remind” before the word “Call.” Such a determination may thereafter be utilized to update grammar information associated with reminders so that future user inputs related to reminders may be more accurately interpreted.

In an implementation, profile management instructions 124 may obtain information regarding user inputs of a user that were received in response to a task related to a user request. Profile management instructions 124 may update profile information associated with the user based on information regarding the user inputs. Thereafter, other user inputs of the user may be processed based on the updated profile information to determine other user requests associated with the other user inputs.

In one scenario, tasks may be provided to a user to “train” the system to correlate certain user inputs of the user to specific user requests. As an example, a task provided to the user in a training environment may solicit the user to provide a user input to play a song. In response, the user may say “I want to hear Song X.” Although the phrase “I want to hear [song name]” is not typically recognized by a natural language processing system as a user request to play the song “Song X,” the phrase “I want to hear [song name]” may be recognized as correlating to a user request to play a song based on a determination that the task (which is related to a song playback request) solicited the phrase spoken by the user and that “Song X” is a song. The phrase may thereafter be saved to the user's profile information so that, when the user subsequently utters a phrase that comprises “I want to hear [song name]” (e.g., outside the training environment), a natural language processing system having access to the user's profile information will understand that the user's utterance corresponds to a user request to play a song.

Activity Analysis

Analysis of activities of users may be performed to deduce information about the users, formulate presentations of the activities for the users, or provide other benefits. As an example, deduced information about a user may indicate interests of the user, habits of the user, places that the user is likely to visit, the times at which the user is likely to visit certain places, friends of the user, people that the user prefers to avoid or encounter, or other information. Presentations of the activities may comprise a comparison of the categories of activities of a user, a comparison of the categories of activities of a set of users, a comparison between activities of a user and activities of a set of users, an accumulation of rewards earned by a user or a set of users, a list of activities of a user or a set of users, or other information.

In an implementation, information indicating user requests that have been invoked (and/or executed) on behalf of user may be stored in database(s) 130 (e.g., a history database). Usage of the user requests of users may be analyzed based on the stored information. As an example, activity analysis instructions 127 may analyze the stored information to provide analysis results of categories of user requests that have been invoked (or executed) on behalf of a user or a set of users, the amount of user requests that have been invoked (or executed) in each category, categories of users requests that have yet to be invoked (or executed) on behalf of the user or the set of users, etc. Thereafter, activity analysis instructions 127 may generate a graphical representation (or other representation) of the analysis results for presentation to one or more users. Users may, for instance, be presented with a graphical representation of categories of user requests that they frequently utilize, categories of user requests that they rarely utilize, categories of user requests that they have not yet used, categories that other users have utilized, etc. In this way, a user may be encouraged to try submitting user requests of categories that were previously unknown to the user if, for example, the graphical representation indicates that previously-unknown categories are popular among other users. In addition, users may be inclined to start reusing (or increase their usage of) categories of user requests if the graphical representation indicates that those categories are popular among other users.

In an implementation, activity analysis instructions 127 may analyze information indicating tasks that have been performed by users and/or requests that have been invoked (or executed) in response to performance of the tasks to provide analysis results regarding the categories of tasks and/or user requests. As an example, the analysis results regarding the categories of tasks and/or user requests may comprise categories of tasks that have been perform by a user or a set of users, categories of user requests invoked (or executed) in response to the tasks, the amount of tasks that have been performed by the user or the set of users in each category, the amount of user requests invoked (or executed) in response to the tasks in each category, categories of tasks or users requests that have yet to be performed or invoked by/on behalf of the user or the set of users, etc. Activity analysis instructions 127 may then generate a graphical representation (or other representation) of the analysis results for presentation to one or more users.

In an implementation, activity analysis instructions 127 may analyze the efficiency in which tasks were performed or user requests were submitted by users and/or attempts by users to perform tasks or submit user requests. As an example, such analysis results may comprise the number of user inputs (or iterations of user inputs) that a user provided for a task before a set of user inputs are deemed sufficient for invoking a user request related to the task, the number of responses (or iteration of responses) provided to the user to solicit the user inputs, an amount of guidance provided to the user before receipt of a set of user inputs deemed sufficient for invoking the user request, etc. As another example, the analysis results may comprise tasks that have not yet been attempted by users, tasks and/or user requests that were attempted by users but not performed/invoked, tasks that were successfully performed by users, user requests that were invoked in response to performance of the tasks, etc. With respect to each of the foregoing analysis result examples, activity analysis instructions 127 may generate a graphical representation (or other representation) of the analysis results for presentation to one or more users.

Other Implementations

It should be appreciated that although the various instructions are illustrated in FIG. 1 as being co-located within a single computing device 110, one or more instructions may be executed remotely from the other instructions. For example, some computing devices 110 of computer system 104 may be programmed by some instructions while other computing devices 110 may be programmed by other instructions, as would be appreciated. Furthermore, the various instructions described herein are exemplary only. Other configurations and numbers of instructions may be used, so long as processor(s) 112 are programmed to perform the functions described herein.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor(s) 112 as well as data that may be manipulated by processor(s) 112. The storage device may comprise floppy disks, hard disks, optical disks, tapes, or other storage media for storing computer-executable instructions and/or data.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configure hardware.

User device(s) 160 may include a device that can interact with computer system 104 through network 102. Such user device(s) may include, without limitation, a tablet computing device, a smartphone, a laptop computing device, a desktop computing device, a network-enabled appliance such as a “Smart” television, a vehicle computing device, and/or other device that may interact with computer system 104.

The various databases 130 described herein may be, include, or interface to, for example, an Oracle™ relational database sold commercially by Oracle Corporation. Other databases, such as Informix™, DB2 (Database 2) or other data storage, including file-based (e.g., comma or tab separated files), or query formats, platforms, or resources such as OLAP (On Line Analytical Processing), SQL (Structured Query Language), a SAN (storage area network), Microsoft Access™, MySQL, PostgreSQL, HSpace, Apache Cassandra, MongoDB, Apache CouchDB™, or others may also be used, incorporated, or accessed. The database may comprise one or more such databases that reside in one or more physical devices and in one or more physical locations. The database may store a plurality of types of data and/or files and associated data or file descriptions, administrative information, or any other data. The database(s) 130 may be stored in storage device 114 and/or other storage that is accessible to computer system 104.

Example Natural Language Processing System

FIG. 2 illustrates a system 200 for facilitating natural language processing, according to an implementation of the invention. As shown in FIG. 2, system 200 may comprise input device(s) 210, speech recognition engine(s) 220, natural language processing engine(s) 230, application(s) 240, output device(s) 250, database(s) 130, or other components.

In an implementation, one or more components of system 200 may comprise one or more computer program instructions of FIG. 1 and/or processor(s) 112 programmed with the computer program instructions of FIG. 1. As an example, speech recognition engine(s) 220 and/or natural language processing engine(s) 230 may comprise user input processing instructions 120, grammar management instructions 123, profile management instructions 124, presentation instructions 125, or other instructions.

Input device(s) 210 may comprise an auditory input device (e.g., microphone), a visual input device (e.g., camera), a tactile input device (e.g., touch sensor), an olfactory input device, a gustatory input device, a keyboard, a mouse, or other input devices. Input received at input device(s) 210 may be provided to speech recognition engine(s) 220 and/or natural language processing engine(s) 230.

Speech recognition engine(s) 220 may process one or more inputs received from input device(s) 210 to recognize one or more words represented by the received inputs. As an example, with respect to auditory input, speech recognition engine(s) 220 may process an audio stream captured by an auditory input device to isolate segments of sound of the audio stream. The sound segments (or a representation of the sound segments) are then processed with one or more speech models (e.g., acoustic model, lexicon list, language model, etc.) to recognize one or more words of the received inputs. Upon recognition of the words of received inputs, the recognized words may then be provided to natural language processing engine(s) 230 for further processing. In other examples, natural language processing engine(s) 230 may process one or more other types of inputs (e.g., visual input representing sign language communication, gestures, or other forms of communication) to recognize one or more words represented by the other types of inputs.

Natural language processing engine(s) 230 may receive one or more inputs from input device(s) 210, speech recognition engine(s) 220, application(s) 240, database(s) 130, or other components. As an example, natural language processing engine(s) 230 may process inputs received from input device(s) 210, such as user inputs (e.g., voice, non-voice, etc.), location-based inputs (e.g., GPS data, cell ID, etc.), other sensor data input, or other inputs to determine context information associated with one or more user inputs. As another example, natural language processing engine(s) 230 may obtain grammar information, profile information, context information, or other information from database(s) 130. The obtained information (or context information determined based on inputs from input device(s) 210) may be processed to determine one or more user requests associated with one or more user inputs of a user. In yet another example, natural language processing engine(s) 230 may process one or more recognized words from speech recognition engine(s) 220 and other information (e.g., information from input device(s) 210, application(s) 240, and/or database(s) 130) to determine one or more user requests associated with one or more user inputs of a user.

In an implementation, natural language processing engine(s) 230 may solicit further inputs from a user by responding with a request for more information via output device(s) 250 if, for instance, a user request associated with a user input of a user cannot be determined with sufficient confidence, more information would helpful to process the user request, etc.

In an implementation, upon determination of a user request of a user, natural language processing engine(s) 230 may determine an application 240 suitable for executing the user request, and provide the user request to the application for further processing. In one scenario, the application 240 may provide one or more results of the user request to output device(s) 250 for presentation to the user.

In another scenario, the application 240 may provide the results of the user request to natural language processing engine(s) 230 for further processing. As an example, the results of the user request may comprise intermediate results that are provided as a parameter for another user request of the user that is to be executed at another application 240. As such, the natural language processing engine(s) 230 may generate the other user request based on the intermediate results, and provide the other user request to the other application 240. As another example, natural language processing engine(s) 230 may formulate a natural language response based on the results received from the application 240, and provide the natural language response to output device(s) 250 for presentation to the user.

In an implementation, a given application 240 may obtain profile information, account information, or other information from database(s) 130 to authenticate a user before executing a user request of the user. As an example, the application 240 may be part of a given service provider 140. As such, the application 240 may determine whether the user has access to one or more services associated with the application 240 before executing the user request on behalf of the user.

In an implementation, a given application 240 may obtain content from database(s) 130 and/or content provider(s) 150 to provide one or more results of a user request of a user. In one use case, where the user request comprises a command to play a media item (e.g., song, video clip, movie, etc.), and the application 240 comprises a media stream application, the application 240 may obtain the media item from a given content provider(s) 150 and stream the media item to output device(s) 250 for presentation to the user.

In an implementation, natural language processing engine(s) 230, application(s) 240, or other components may store information in database(s) 130 for later use by natural language processing engine(s) 230, application(s) 240, or other components. As an example, as described in further detail elsewhere herein, natural language processing engine(s) 230 may store information regarding user inputs in database(s) 130 and/or update profile information, grammar information, or other information in database(s) 130 based on the information regarding the user inputs.

Example Flow Diagrams

The following flow diagrams describe operations that may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

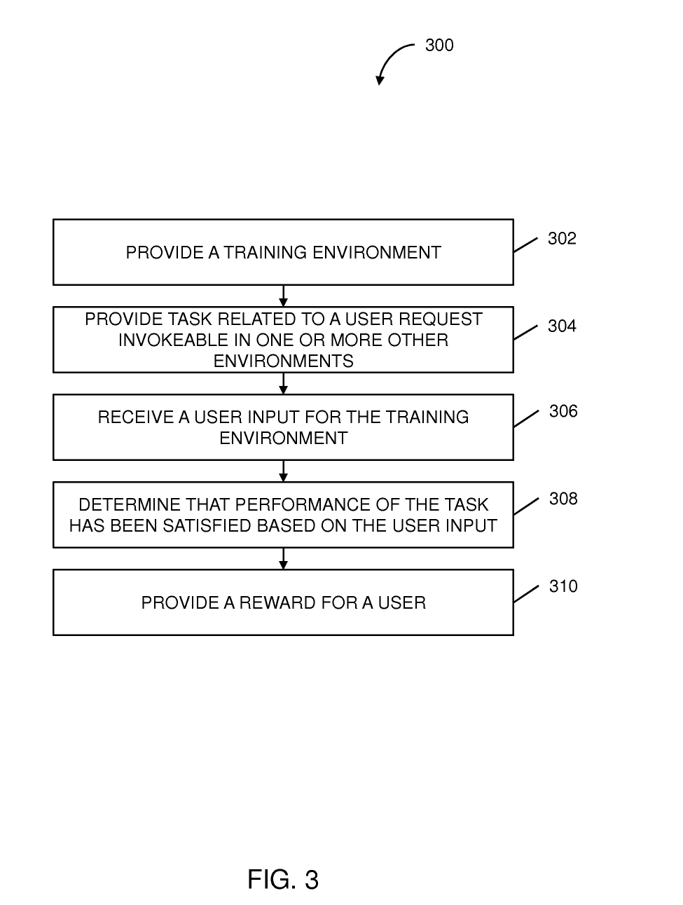

FIG. 3 illustrates a flow diagram for a method of providing task-based solicitation of request-related user inputs, according to an implementation of the invention.

In an operation 302, a training environment may be provided. In an operation 304, a task to be performed may be provided. The task may be related to a user request that is invokeable in one or more other environments different than the training environment.

In an operation 306, one or more user inputs maybe received for the training environment. The user inputs may comprise an auditory input, a visual input, a tactile input, an olfactory input, a gustatory input, a keyboard input, a mouse input, or other user input.

In an operation 308, performance of the task may be determined to be satisfied based on the user inputs. As an example, performance of the task may be determined to be satisfied based on a determination that the user request would have been invoked in the other environments if the user inputs had been received for the other environments.

In an operation 310, a reward may be provided for a user in response to a determination that performance of the task has been satisfied. As an example, the reward may comprise points, badges, real-world money, virtual currency, promotional offers, products, services, or other reward. As another example, the reward may comprise enablement of access of the user to one or more features, such as access to features of the other environments that were previously disabled to the user prior to the performance of the task being satisfied.

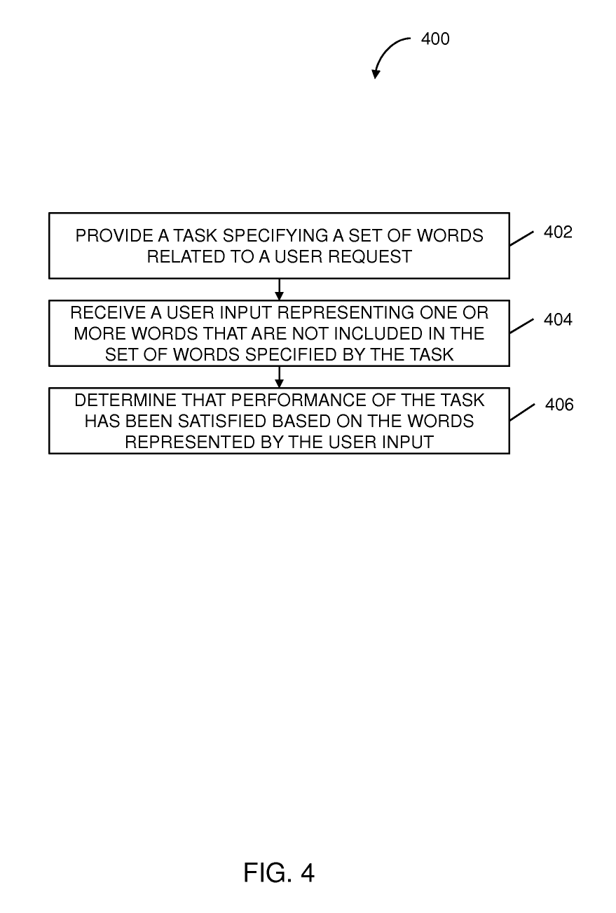

FIG. 4 illustrates a flow diagram for a method of providing task-based solicitation of request-related natural language inputs that comprise representations of words, according to an implementation of the invention.

In an operation 402, a task (that specifies a set of words related to a user request) may be provided. As an example, the task may specify a phrase related to the user request that can be provided by a user to invoke the user request.

In an operation 404, a user input representing one or more words (that are not included in the set of words specified by the task) may be received.

In an operation 406, performance of the task may be determined to be satisfied based on the words represented by the user input. As an example, the task may be deemed to be satisfied based on a determination that the user request related to the task can be determined (e.g., with sufficient confidence) from the words represented by the user input (without having knowledge of the task).

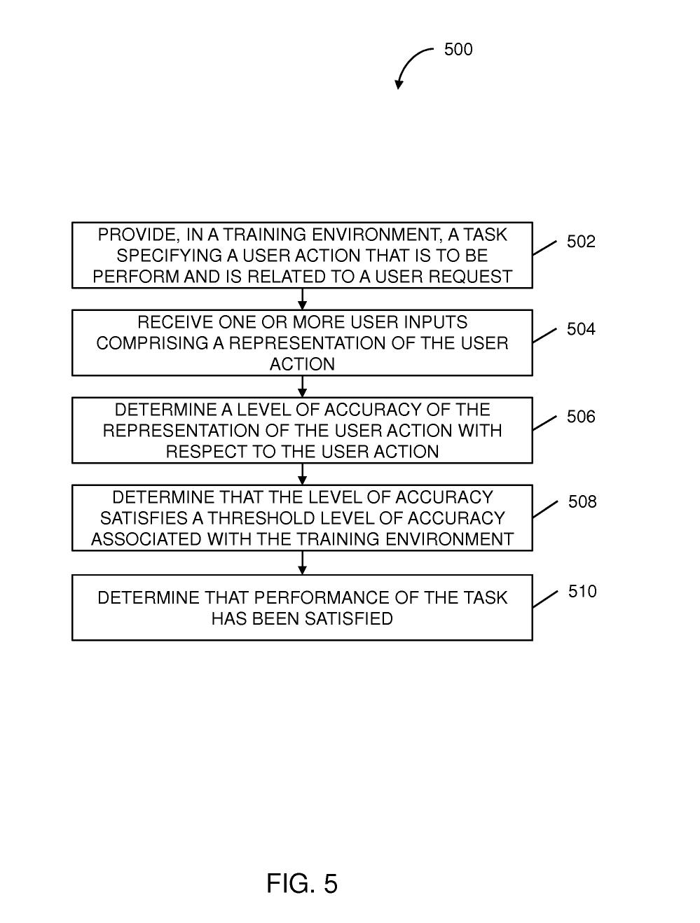

FIG. 5 illustrates a flow diagram for a method of assessing performance of a task based on a threshold level of accuracy associated with a training environment, according to an implementation of the invention.

In an operation 502, a task specifying a user action that is to be performed may be provided in a training environment. The specified user action may relate to a user request. The user request may be invokeable in one or more other environments (different than the training environment).

In an operation 504, one or more user inputs may be received. The user inputs may comprise a representation of the specified user action.

In an operation 506, a level of accuracy of the representation of the specified user action with respect to the specified user action may be determined. As an example, the level of accuracy may be determined based on similarities the portions of the representation from the user input and the portions of a predefined representation of the specified action (e.g., similarities between sounds of the corresponding portions), similarities between the order of the portions of the representation from the user input and the order of the portions of the predefined representation of the specified action (e.g., similarities with respect to how represented words are ordered), or other criteria.

In an operation 508, the level of accuracy may be determined to satisfy a threshold level of accuracy associated with the training environment.

In an operation 510, a determination that performance of the task has been satisfied may be effectuated. For example, the determination with respect to performance of the task may be in response to the determination that the level of accuracy satisfies the threshold level of accuracy associated with the training environment.

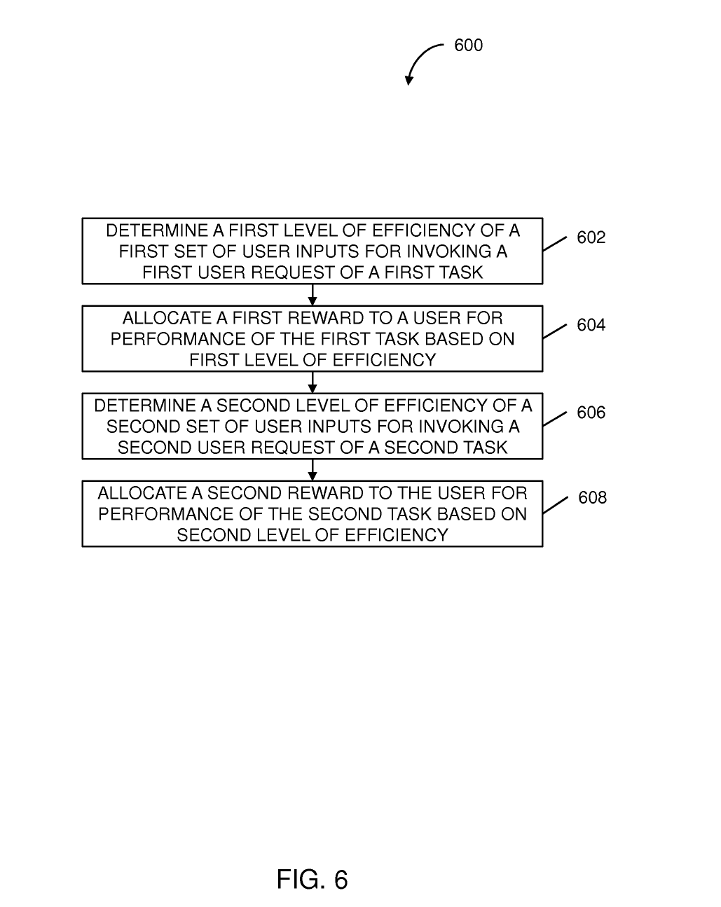

FIG. 6 illustrates a flow diagram for a method of allocating rewards based on efficiency of user inputs for invoking user requests, according to an implementation of the invention.

In an operation 602, a first level of efficiency of a first set of user inputs for invoking a first user request of a first task may be determined. As an example, a level of efficiency may be determined based on the number of user inputs (or iterations of user inputs) that a user provided for a task before a set of user inputs are deemed sufficient for invoking a user request related to the task, the number of responses (or iteration of responses) provided to the user to solicit the user inputs, an amount of guidance provided to the user before receipt of a set of user inputs deemed sufficient for invoking the user request, etc.

In an operation 604, a first reward may be allocated to the user for performance of a first task based on the first level of efficiency.

In an operation 606, a second level of efficiency of a second set of user inputs for invoking a second user request of a second task may be determined.

In an operation 608, a second reward may be allocated to the user for performance of a second task based on the second level of efficiency. The second reward may be different then the first reward (e.g., different in amount, different in reward type, etc.) based on the second level of efficiency being different than the first level of efficiency.

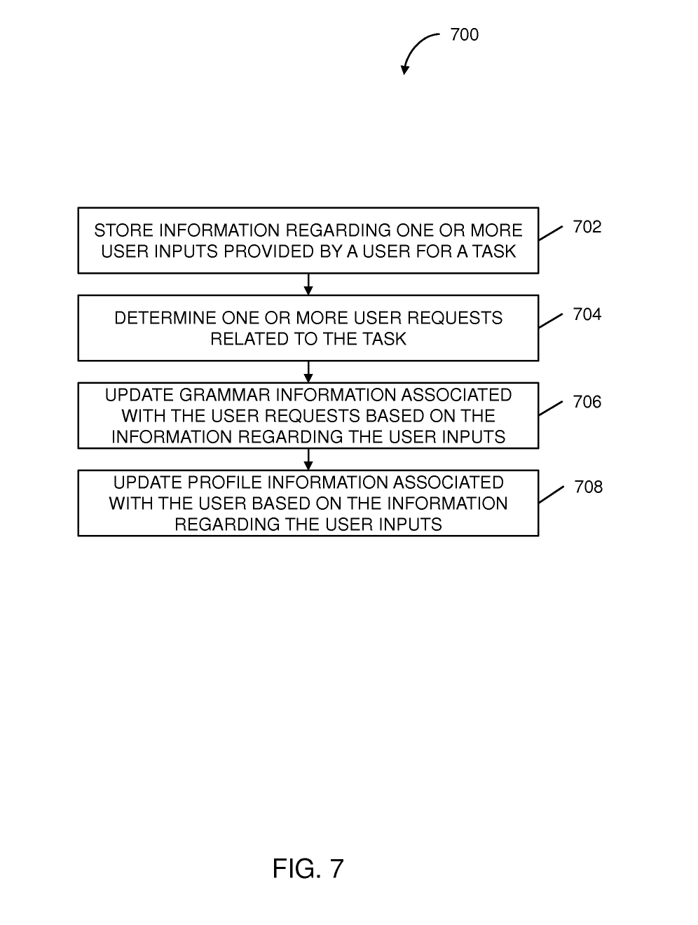

FIG. 7 illustrates a flow diagram for a method of updating grammar and/or profile information based on information regarding user inputs provided for tasks, according to an implementation of the invention.

In an operation 702, information regarding one or more user inputs (provided by a user for a task) may be stored. Such information (e.g., determined based on a processing of the user inputs) may indicate words represented by a user input, the order in which the words are represented by the user input, intensities of the user input (e.g., speed, volume, power per unit area, etc.), pitches of the user input (e.g., a user's pitches in speaking various words of an utterance), variations of the user input with respect to a predefined norm (e.g., a user's pronunciations of words compared to a predefined pronunciation of those words), or other information.

In an operation 704, one or more user request related to the task may be determined. As an example, the determined requests may comprise a user request specified by the task.

In an operation 706, grammar information associated with the determined user requests may be updated based on the information regarding the user inputs.

In an operation 708, profile information associated with the user may be updated based on the information regarding the user inputs.

Example Screenshots

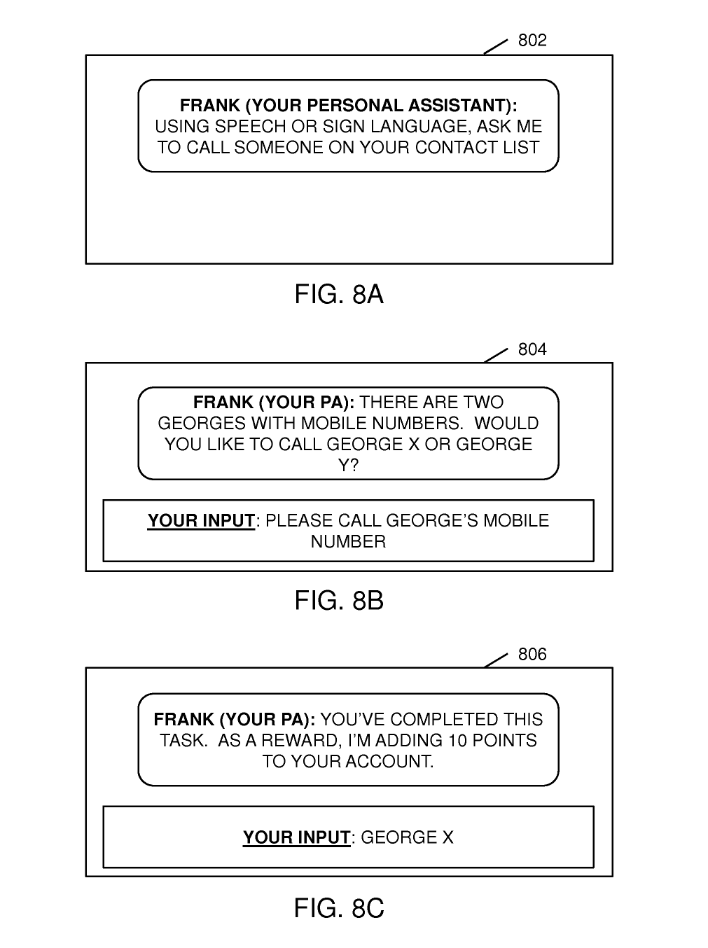

FIGS. 8A-8C illustrates screenshots 802, 804, and 806 of a user interface which facilitates task-based solicitation of request-related user inputs, according to an implementation of the invention. As shown in screenshot 802 of FIG. 8A, an automated personal assistant may present a task to a user that specifies that the user use speech or sign language to ask the personal assistant to call someone in the user's contact list on behalf of the user. As depicted in screenshot 804 of FIG. 8B, the user may say (or sign) “Please call George's mobile number” in response to the task. However, because there are two Georges in the user's contact list, the personal assistant may respond to the user by asking the user to clarify which George should be called. As shown in screenshot 806 of FIG. 8C, the user may say (or sign) “George X” in response to the personal assistant's request for clarification. Thereafter, it may be determined that the user's inputs (e.g., “Please call George's Mobile Number” and “George X”) are sufficient for invoking a call request. As such, upon determining that the user's inputs are sufficient for invoking the user request specified by the task, it may be determined that the user has completed the task, and a reward may be provided for the user.

As illustrated in screenshot 806 of FIG. 8C, a reward of 10 points may be allocated to the user's account for completing the task. The reward of 10 points may, for example, be based on an efficiency of the user in completing the task and/or providing user inputs that are sufficient for invoking the user request related to the task. In one scenario, it may be determined that two iterations of user inputs were received from the user before the user inputs of the user were sufficient for invoking the related user request or that one iteration of response from the personal assistant to a user input of the user was provided before the user inputs of the user were sufficient for invoking the related user request. An efficiency of the user in providing the user inputs may then be determined based on the number of iterations of user inputs, the number of iterations of responses from the personal assistant, or other criteria. The reward may thereafter be calculated based on the efficiency or other criteria.

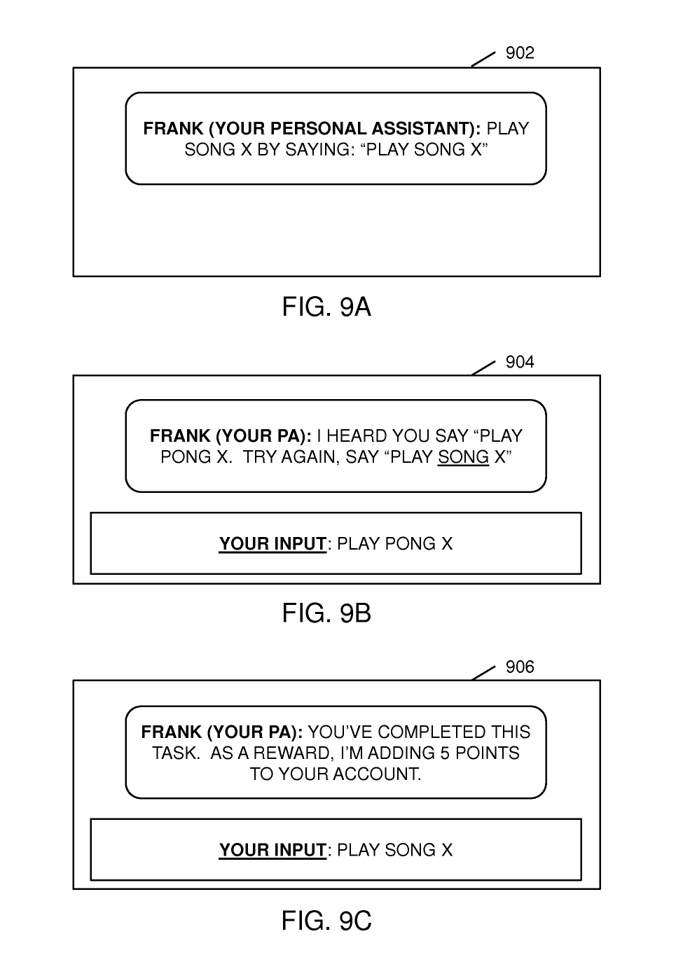

FIGS. 9A-9C illustrates screenshots 902, 904, and 906 of a user interface which facilitates task-based solicitation of request-related user inputs, according to an implementation of the invention. As shown in screenshot 902 of FIG. 9A, an automated personal assistant may present a task to a user that specifies that the user submit a specific user request by saying a specific phrase. As illustrated in screenshot 904 of FIG. 9B, the user may attempt to say the specific phrase, but the user's speech may be recognized as “Play Pong X.” The recognized phrase may not be deemed to be sufficiently accurate with respect to the specified phrase “Play Song X.” As such, the personal assistant may respond to the user by informing the user that the personal assistant heard the user say “Play Pong X,” and to try saying “Play Song X” again. As shown in screenshot 906 of FIG. 9C, the user's subsequent input may be recognized as “Play Song X.” Thus, the user's subsequent input may have been deemed sufficiently accurate with respect to the specified phrase, and performance of the task may be determined to be satisfied.

In one use case, with respect to FIGS. 9A-9C, the task may be presented to the user in a training environment (e.g., via a speech-based user request training application). The criteria for the training environment for successfully “invoking” a user request specified by a task may be different than the criteria for invoking the user request in one or more other environments. As an example, the threshold level of accuracy associated with the training environment for user inputs to satisfy the task in the training environment may be greater than the threshold level of accuracy associated with another environment for user inputs to invoke the user request in the other environment. In this way, the training environment may train users to provide user inputs with higher levels of accuracy than what is required outside of the training environment.

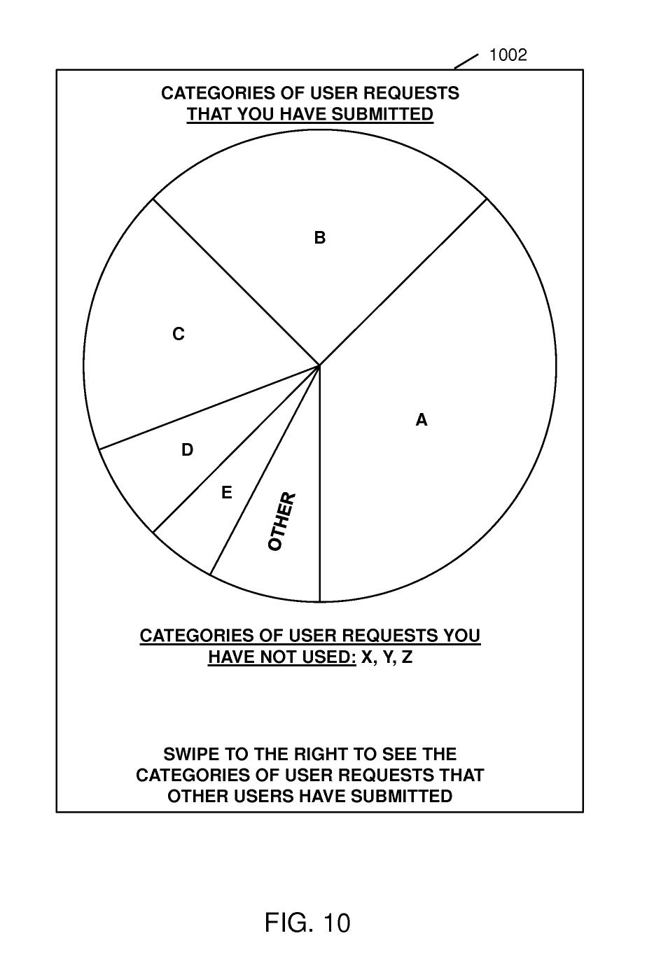

FIG. 10 illustrates a screenshot 1002 of a user interface that provides a comparison between categories of user requests submitted by a user, according to an implementation of the invention. As an example, an analysis of user requests that a user has submitted may be performed to determine categories of the user requests submitted by the user and the percentages of the user requests submitted by the user in one or more of the determined categories. As shown in screenshot 1002 of FIG. 10, a graphical representation of the analysis results may be presented to the user. The graphical representation indicates, for instance, that the largest percentage of the user requests submitted by the user are related to Category A, the second largest percentage of the user requests submitted by the user are related to Category B, the third largest percentage of the user requests submitted by the user are related to Category C, and so on. One or more categories in which the user has not yet submitted user requests may also be presented to the user (e.g., Categories X, Y, and Z). In addition, as indicated in screenshot 1002 of FIG. 10, the user may “swipe to the right” to view a graphical representation of analysis results of categories of user requests that other users have submitted, categories in which other users have not yet submitted user requests, etc.

As another example, an analysis of tasks performed by a user and/or user requests invoked (or executed) in response to user inputs provided for the tasks may be performed to determine categories of tasks performed by the user and/or categories of user requests invoked (or executed) in response to user inputs provided for the tasks. The analysis results may then be presented to the user to show the user the categories of performed tasks, the categories of the remaining tasks, the categories of the user requests invoked/executed on behalf of the user in response to tasks, and/or the categories of the user requests of the remaining tasks that have yet to be invoked (or executed) on behalf of the user.

As yet another example, an analysis of tasks performed by a set of user and/or user requests invoked (or executed) in response to user inputs provided by the set of users for the tasks may be performed to determine categories of tasks performed by the set of users and/or categories of user requests invoked (or executed) in response to user inputs provided by the set of users for the tasks. The analysis results may then be presented to the user to show the user the categories of the tasks performed by the set of users, the categories of the remaining tasks that have yet to be performed the set of users, the categories of the user requests invoked/executed on behalf of the set of users in response to tasks, and/or the categories of the user requests of the remaining tasks that have yet to be invoked (or executed) on behalf of the set of users.

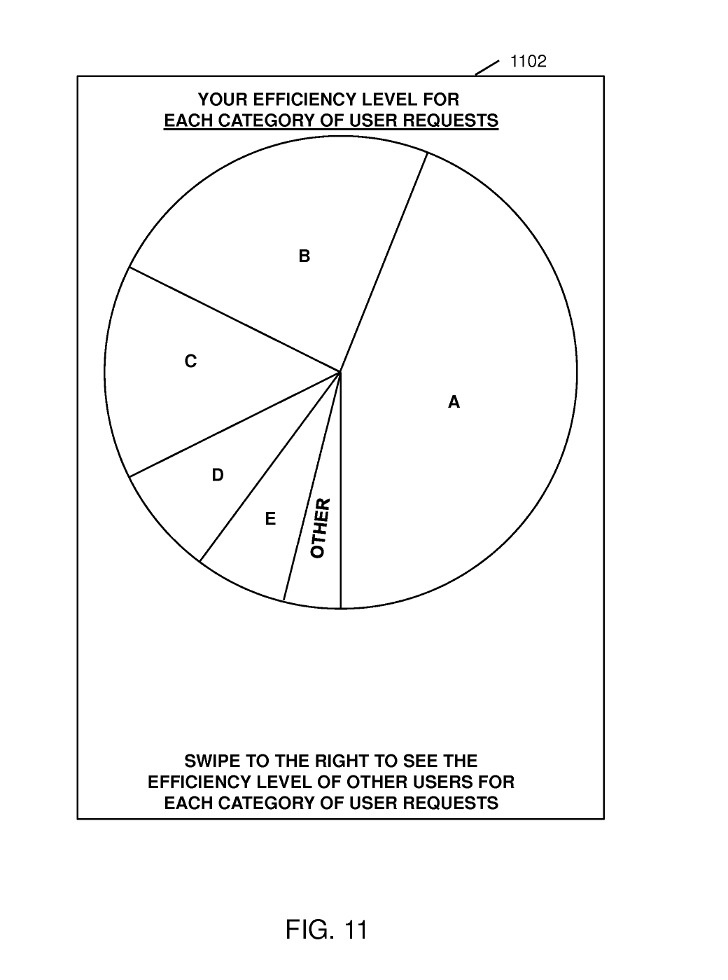

FIG. 11 illustrates a screenshot 1102 of a user interface that provides a comparison between efficiency levels for each category of user requests submitted by a user, according to an implementation of the invention. As an example, an analysis of user inputs that a user has provided to have user requests invoked/executed may be performed to determine efficiency of the user inputs with respect to each categories of the user requests invoked/executed on behalf of the user. As shown in screenshot 1102 of FIG. 11, a graphical representation of the analysis results may be presented to the user. The graphical representation indicates, for instance, that the user is most efficient in providing user inputs for invoking user requests in Category A (compared to other user requests of other categories). In addition, as indicated in screenshot 1001 of FIG. 11, the user may “swipe to the right” to view a graphical representation of analysis results of the efficiency of other users in providing user inputs for invoking user requests of various categories.

As another example, an analysis of tasks performed by a user and/or user requests invoked (or executed) in response to user inputs provided for the tasks may be performed to determine efficiency of user inputs with respect to each categories of tasks performed by the user and/or each categories of user requests invoked (or executed) in response to user inputs provided for the tasks. The analysis results may then be presented to the user to show the user the efficiency of the user with respect to one or more categories of tasks or user requests related to the tasks.

As yet another example, an analysis of tasks performed by a set of user and/or user requests invoked (or executed) in response to user inputs provided by the set of users for the tasks may be performed to determine efficiency of user inputs with respect to each categories of tasks performed by the set of users and/or each categories of user requests invoked (or executed) in response to user inputs provided by the set of users for the tasks. The analysis results may then be presented to the user to show the user the efficiency of the set of users with respect to one or more categories of tasks or user requests related to the tasks.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method of providing task-based solicitation of request-related user inputs in a training environment to facilitate natural language processing of request-related user inputs in an environment different than the training environment, the method being implemented on a computer system that includes one or more physical processors executing computer program instructions which, when executed by the one or more physical processors, perform the method, the method comprising:
providing, by the computer system, a training environment;
providing, by the computer system, a task that is to be performed, wherein the task is related to a user request that is invokeable in one or more other environments different than the training environment;
receiving, at the computer system, one or more user inputs for the training environment;
determining, by the computer system, whether performance of the task has been satisfied based on the one or more user inputs; and
providing, by the computer system, a reward for a user in response to a determination that performance of the task has been satisfied.

2. The method of claim 1, wherein determining whether performance of the task has been satisfied comprises determining whether the user request would have been invoked in the one or more other environments if the one or more user inputs had been received for the one or more other environments, and wherein providing the reward comprises providing the reward for the user in response to a determination that the user request would have been invoked in the one or more other environments if the one or more user inputs had been received for the one or more other environments.

3. The method of claim 1, wherein receiving the one or more user inputs comprises receiving a representation of one or more words that are not specified by the task, and wherein determining whether performance of the task has been satisfied comprises determining whether performance of the task has been satisfied based on the one or more words.

4. The method of claim 3, wherein the task specifies a set of words related to the user request, and wherein the set of words do not comprise the one or more words.

5. The method of claim 1, wherein the task comprises a specified user action that is to be performed and that is related to the user request, wherein receiving the one or more user inputs comprises receiving a representation of the specified user action for the training environment, the method further comprising:
determining, by the computer system, a level of accuracy of the representation of the specified user action with respect to the specified user action;
determining, by the computer system, whether the level of accuracy satisfies a threshold level of accuracy associated with the training environment,
wherein the determination that performance of the task has been satisfied is based on the determination that the level of accuracy satisfies the threshold level of accuracy associated with the training environment, and
wherein the threshold level of accuracy associated with the training environment is different than a threshold level of accuracy for invoking the user request in the one or more other environments.

6. The method of claim 5, wherein the threshold level of accuracy for invoking the user request in the one or more other environments is greater than the threshold level of accuracy associated with the training environment.

7. The method of claim 5, wherein the threshold level of accuracy for invoking the user request in the one or more other environments is less than the threshold level of accuracy associated with the training environment.

8. The method of claim 1, wherein the user request is not invoked in the one or more other environments despite the determination that performance of the task has been satisfied.

9. The method of claim 1, wherein the user request is not invoked in the one or more other environments despite the determination that the user request would have been invoked in the one or more other environments if the one or more user inputs had been received for the one or more other environments.

10. The method of claim 1, wherein the user request is not invoked despite the determination that performance of the task has been satisfied.

11. The method of claim 1, further comprising:
determining, by the computer system, a level of efficiency of the one or more user inputs for invoking the user request in the one or more other environments,
wherein providing the reward comprises providing the reward for the user further in response to the level of efficiency.

12. The method of claim 11, further comprising:
providing, by the computer system, a second task that is to be performed, wherein the second task is related to a second user request that is invokeable in the one or more other environments;
receiving, at the computer system, one or more second user inputs for the training environment;
determining, by the computer system, whether performance of the second task has been satisfied based on the one or more second user inputs;
determining, by the computer system, a second level of efficiency of the one or more second user inputs for invoking the second user request in the one or more other environments, wherein the second level of efficiency is different than the level of efficiency of the one or more user inputs; and
providing, by the computer system, a second reward for a user in response to the second level of efficiency and a determination that performance of the second task has been satisfied such that the second reward is different than the reward based on the second level of efficiency being different than the first level of efficiency.

13. The method of claim 1, further comprising:
determining, by the computer system, an amount of guidance related to the task that is provided to the user prior to the receipt of the one or more user inputs,
wherein providing the reward comprises providing the reward for the user further in response to the amount of guidance.

14. The method of claim 1, further comprising:
storing, by the computer system, information regarding the one or more user inputs; and
determining, by the computer system, one or more user requests related to the task that are invokeable in the one or more other environments;
updating, by the computer system, grammar information associated with the one or more user requests based on the information regarding the one or more user inputs;
receiving, at the computer system, one or more other user inputs of another user for the one or more other environments; and
determining, by the computer system, at least one user request of the other user based on the one or more other user inputs and the updated grammar information.

15. The method of claim 1, further comprising:
updating, by the computer system, profile information associated with the user based on information regarding the one or more user inputs;
receiving, at the computer system, one or more other user inputs of the user for the one or more other environments; and
determining, by the computer system, at least one user request of the user based on the one or more other user inputs and the updated profile information.

16. The method of claim 1, wherein, prior to the determination that performance of the task has been satisfied, access of the user to one or more features associated with the one or more other environments is disabled, the method further comprising:
enabling, by the computer system, access of the user to the one or more features in response to the determination that performance of the task has been satisfied.

17. The method of claim 16, further comprising:
modifying, by the computer system, a level associated with the user from a first level of the training environment to a second level of the training environment in response to the determination that performance of the task has been satisfied,
wherein enabling access of the user to the one or more features comprises enabling access of the user to the one or more features associated with the one or more other environments in response to the modification of the level associated with the user.

18. The method of claim 16, wherein the one or more features comprises one or more user requests that are invokeable in the one or more other environments, and wherein enabling access of the user to the one or more features comprises enabling access of the user to invoke the one or more user requests in the one or more other environments in response to the determination that performance of the task has been satisfied.

19. A method of providing task-based solicitation of request-related user inputs, the method being implemented on a computer system that includes one or more physical processors executing computer program instructions which, when executed, perform the method, the method comprising:
providing, by the computer system, a task that is to be performed and that is related to a user request;
receiving, at the computer system, one or more user inputs comprising a representation of one or more words that are not specified by the task;
determining, by the computer system, whether performance of the task has been satisfied based on the representation of the one or more words; and
providing, by the computer system, a reward for a user in response to a determination that performance of the task has been satisfied.

20. The method of claim 19, wherein the task specifies a set of words related to the user request, and wherein the set of words do not comprise the one or more words.

21. The method of claim 19, further comprising:
invoking, by the computer system, the user request in response to the receipt of the one or more user inputs; and
determining, by the computer system, a level of efficiency of the one or more user inputs in invoking the user request,
wherein providing the reward comprises providing the reward for the user further in response to the level of efficiency.

22. The method of claim 19, further comprising:
determining, by the computer system, an amount of guidance related to the task that is provided to the user prior to the receipt of the one or more user inputs,
wherein providing the reward comprises providing the reward for the user further in response to the amount of guidance.

23. The method of claim 1, wherein, prior to the determination that performance of the task has been satisfied, access of the user to one or more features available via the computer system is disabled, the method further comprising:
enabling, by the computer system, access of the user to the one or more features in response to the determination that performance of the task has been satisfied.

24. The method of claim 23, wherein the one or more features comprises one or more user requests available to at least one user of the computer system, and wherein enabling access of the user to the one or more features comprises enabling access of the user to invoke the one or more user requests via the computer system in response to the determination that performance of the task has been satisfied.

25. A system for providing task-based solicitation of request-related user inputs in a training environment to facilitate natural language processing of request-related user inputs in an environment different than the training environment, the system comprising:
one or more physical processors programmed with computer program instructions which, when executed, cause the one or more physical processors to:
provide a training environment;
provide a task that is to be performed, wherein the task is related to a user request that is invokeable in one or more other environments different than the training environment;
receive one or more user inputs for the training environment;
determine whether performance of the task has been satisfied based on the one or more user inputs; and
provide a reward for a user in response to a determination that performance of the task has been satisfied.

26. The system of claim 25, wherein determining whether performance of the task has been satisfied comprises determining whether the user request would have been invoked in the one or more other environments if the one or more user inputs had been received for the one or more other environments, and wherein providing the reward comprises providing the reward for the user in response to a determination that the user request would have been invoked in the one or more other environments if the one or more user inputs had been received for the one or more other environments.

27. The system of claim 25, wherein receiving the one or more user inputs comprises receiving a representation of one or more words that are not specified by the task, and wherein determining whether performance of the task has been satisfied comprises determining whether performance of the task has been satisfied based on the one or more words.

28. The method of claim 27, wherein the task specifies a set of words related to the user request, and wherein the set of words do not comprise the one or more words.

29. A system of providing task-based solicitation of request-related user inputs, the system comprising:
one or more physical processors programmed with computer program instructions which, when executed, cause the one or more physical processors to:
provide a task that is to be performed and that is related to a user request;
receive one or more user inputs comprising a representation of one or more words that are not specified by the task;
determine whether performance of the task has been satisfied based on the representation of the one or more words; and
provide a reward for a user in response to a determination that performance of the task has been satisfied.

30. The system of claim 29, wherein the task specifies a set of words related to the user request, and wherein the set of words do not comprise the one or more words.
